(19) United States
(12) Patent Application Publication
(10) Pub. No.: US 2010/0021682 A1
(43) Pub. Date: Jan. 28, 2010

(54) COMPOSITE MATERIAL AND METHOD FOR INCREASING Z-AXIS THERMAL CONDUCTIVITY OF COMPOSITE SHEET MATERIAL

(75) Inventors: Zhiyong Liang, Tallahassee, FL (US); Ben Wang, Tallahassee, FL (US); Chun Zhang, Tallahassee, FL (US); Michael M. Zimmer, Tallahassee, FL (US)

Correspondence Address: SUTHERLAND ASBILL & BRENNAN LLP, 999 PEACHTREE STREET, N.E., ATLANTA, GA, 30309, US

(73) Assignee: FLORIDA STATE UNIVERSITY RESEARCH FOUNDATION, Tallahassee, FL (US)

(21) Appl. No.: 12/507,302

(22) Filed: Jul. 22, 2009

Related U.S. Application Data
(60) Provisional application No. 61/083,786, filed on Jul. 25, 2008.

(51) Int. Cl. B32B 3/02; B05D 7/02; D04H 11/00; D03D 25/00; D03D 11/00; D05B 1/00

(52) U.S. Cl. 428/103; 427/322; 427/299; 442/301; 442/414; 442/377; 442/229; 442/239; 442/381; 112/475.01; 977/742

(57) ABSTRACT

Methods are provided for making a composite material that includes (a) providing at least one sheet which includes woven or non-woven glass fibers, carbon fibers, aramid fibers, or nanoscale fibers; and (b) stitching a plurality of stitches of a thermally conductive fiber through the at least one sheet in a Z-axis direction to form paths of higher conductivity through the sheet of material to increase its thermal conductivity in the Z-axis.

### CROSS-REFERENCE TO RELATED APPLICATION

This application claims benefit of U.S. Provisional Application No. 61/083,786, filed Jul. 25, 2008, which is incorporated herein by reference.

### BACKGROUND OF THE INVENTION

This invention relates generally to structural composite materials, and more particularly to composite and methods for imparting higher through-thickness thermal conductivity to laminate and other composite material structures.

In conventional fiber-reinforced composites, few, if any, through-thickness conducting paths exist due to the microstructure nature of the composites (e.g., in-plane or 2D laminate structures and chopped fiber/resin mixture structures). Therefore, the composites' through-thickness thermal conductivities are usually only slightly higher than those of neat resin matrices. For example, the through-thickness thermal conductivity of carbon fiber-reinforced, resin matrix composite laminates is usually about 0.2-0.4 W/mK; and the through-thickness thermal conductivity of 2-D carbon-carbon composites is about 20 W/mK. These values are typically lower than those of metallic materials, such as aluminum and copper, used in thermal management applications.

Products for improving thermal conductivity, such as Z-pins (Gardner, S., Lockheed Martin Corp., 2003) and Zspreaders (GrafTech Int. Ltd., 2007) are conductive materials that are inserted in the Z-axis direction (through-thickness) direction of composite materials that are continuous in the X-Y axis directions. The use of Z-pins involves a costly post-process using small (e.g., sub-millimeter) diameter cured composite rods. A Z-spreader is an additive component which attaches to the composite at holes made in the composite into which Z-inserts fit. The process of forming the holes in the composite, however, may damage fibers and/or a resin matrix of the composite. Therefore, while these Z-pin products may increase a composite's through-thickness thermal conductivity, it may unintentionally and undesirably diminish certain strength or other desirable properties of the composite material.

Therefore, it would be desirable to provide a composite sheet or laminate material that has enhanced through-thickness thermal conductivity. It also would be desirable to provide a process for increasing the through-thickness thermal conductivity of a composite sheet using methods and materials that avoid or reduce the aforementioned deficiencies and that are more cost effective.

### SUMMARY OF THE INVENTION

Methods for making a composite material and a method of making the same have been developed. The method increases the Z-axis thermal conductivity of the composite material. In certain embodiments, the method for making a composite material comprises providing at least one sheet which comprise woven or non-woven fibers and stitching a plurality of stitches of a thermally conductive fiber through the at least one sheet, thereby forming a stitched composite material. The woven or non-woven fibers comprise glass fibers, carbon fibers, aramid fibers, or nanoscale fibers.

In one embodiment, following the stitching, the thermally conductive fiber is present in the stitched composite material in an amount from about 0.5 volume % to about 30 volume % of the stitched composite material.

In some embodiments, the stitching comprises single through-stitching. In other embodiments, the stitching comprises over-and-under stitching.

In certain embodiments, the thermally conductive fiber comprises a metallic wire, carbon fibers, a nanoscale composite fiber, a carbon nanotube yarn, a metal-coated polymeric monofilament, or a metal-coated polymeric yarn.

In some embodiments, the sheet comprises a fiber weave and the stitching threads the thermally conductive fiber between the fibers of the fiber weave. In one embodiment, two or more of the sheets which comprise woven or non-woven fibers are stitched together with the thermally conductive fiber.

In certain embodiments the method further comprises impregnating the stitched composite material with a resin and then curing or B-stage curing the resin.

In another aspect, a composite sheet material is provided. The composite sheet material includes at least one sheet which comprise woven or non-woven fibers and a plurality of stitches of a thermally conductive fiber through the at least one sheet. The woven or non-woven fibers comprise glass fibers, carbon fibers, aramid fibers, or nanoscale fibers. The thermally conductive fiber is present in the composite sheet material in an amount of at least about 0.5 volume % of the composite material.

In certain embodiments, the composite sheet material further comprises a polymeric matrix material, a carbon matrix material, a metal matrix material, or a ceramic matrix material. In one embodiment, the composite sheet material further comprises a polymeric matrix material which is a cured or B-stage cured resin.

### BRIEF DESCRIPTION OF THE DRAWINGS

FIG. 1 illustrates two embodiments of the method for stitching a sheet material with a thermally conductive fiber material, to make a composite material having increased Z-axis thermal conductivity.

FIG. 2 illustrates an embodiment of a composite material comprising two sheets of non-woven fibers, a plurality of stitches of a thermally conductive fiber, and a polymeric matrix material.

FIG. 3 is a graph showing thermal diffusivity versus temperature for one embodiment of a neat fiberglass/epoxy composite.

FIG. 4 is a graph showing thermal diffusivity versus temperature for one embodiment of a Fiberglass/epoxy composite with 1.8% volume fraction (V_{f}) copper stitching.

FIG. 5 is a graph showing thermal diffusivity versus temperature for one embodiment of a fiberglass/epoxy composite with 0.4% V_{f} carbon nanotube yarn stitching.

FIG. 6 is a graph showing thermal diffusivity versus temperature for one embodiment of a fiberglass/epoxy composite with 5.0% V_{f} copper stitching.

### DETAILED DESCRIPTION OF THE INVENTION

Composite materials and methods for making composite materials have been developed to provide increased thermal conductivity in the Z-axis, or through-thickness direction, of a sheet material (such as a fiber-reinforced polymeric composite or a carbon-carbon composite). The process includes threading or stitching (e.g., sewing) a pliable, thermally conductive material into and through a sheet of a material in a Z-axis direction to form paths of higher conductivity through the sheet of material to increase its thermal conductivity in the Z-axis. That is, the path, i.e., a stitch, consisting of the thermally conductive material has a higher thermal conductivity than the surrounding material of the sheet. The pliable, thermally conductive material (generally referred to herein as a “thermally conductive fiber”) may be in the form of a metallic and/or non-metallic wire. thread, cord, ribbon, or yarn, as detailed below. The stitching beneficially avoids or minimizes disruption of the sheet's internal structure (especially the carbon, glass, or nanoscale fibers therein, which are oriented primarily in the X- and/or Y-axis of the sheet), in contrast to holes made by conventional conductivity enhancing methods, so that the mechanical properties of the composite remain largely unaffected by the process of creating the thermal conduction pathways in the composite.

High thermal conductivity in composites is desirable in thermal management with many different structural components, including managing the heat transfer through sheet structures in the Z-direction, or thickness direction. Without wishing to be bound by any particular theory, one mechanism of heat transfer responsible for the thermal conductivity of composite materials is phonon thermal conductivity. Phonon thermal conductivity may be characterized as the displacement of one or more atoms from their equilibrium positions, thus giving rise to a set of vibration waves, or phonons, propagating through the composite lattice due to interactions between atoms. Phonons may be treated as particles traveling at a set frequency. The transportation of phonons is known as phonon-phonon scattering, or normal scattering. Normal scattering involves two incoming phonons with wave-vectors colliding and forming one outgoing phonon with its own wave vector. As long as the sum of the two incoming phonons stays inside the Brillouin zone of a cell of the lattice, the outgoing phonon is the sum of the former two phonons, thus conserving phonon momentum. Therefore, the incoming phonons passes on the heat energy within the frequency domain and the resulting or outgoing phonon travels at a harmonic state.

Thermal conductivity benefits from normal scattering when phonons are free to propagate at a constant periodicity, but the phonons may experience a break in periodicity when they encounter defects or discontinuities in the composite structure. Accordingly, a continuous conductive path, free of defects and disruptions, having a crystalline-like metal or graphite molecular lattice structure, would promote an effective and efficient means of producing high thermal conductivity in composites. In view of this principle, the composite materials and methods described herein are believed to provide continuous, thermally conductive paths, which are substantially free of defects and disruptions, in the through-thickness direction.

Advantageously, the composite structures made as described herein largely or completely maintain their desired mechanical properties after addition of the thermal conducting paths provided by the stitching. The composite materials having increased thermal conductivity advantageously enables the composite materials to be used more effectively and efficiently in a myriad of structural and electronics applications, for example in military, electronic, and aerospace industries. These composites provide thermal load solutions, while serving as a lightweight and strong composite material. Therefore, electronics including the composite may be made smaller, without the use of bulky high power cooling systems, may be more reliable, and may have longer life-cycles. Moreover, use of the high thermal conductivity composites may spawn new forms of embedded circuits or more fuel-efficient vehicles.

Another advantage of the process is that good interfacial bonding may be achieved between the stitches and the sheets/composite layers. In one case, for example, the stitching may be performed on a fiber preform or prepreg layup layers, before a composite curing process. Thus, the stitched layer(s) may have sufficient flexibility to be further formed into a desired geometry before applying and curing a resin to form the composite. This can facilitate bonding between thermally conductive material and the surrounding composite material.

The methods described herein for fabricating high through-thickness thermally conductive composites can be highly cost-effective processes. For example, the threading or stitching process may use sewing machines/equipment known in the art. Such equipment can be used to stitch together sheets of various types of textile materials and should be readily adaptable to stitch a pliable thermally conductive material into a sheet of a composite material. In addition, these methods are scalable for mass production.

### The Method of Imparting Increased Z-axis Thermal Conductivity to a Composite

In one aspect, a method is provided for making a composite material that includes the following steps: (i) providing at least one sheet which comprise woven or non-woven fibers, the woven or non-woven fibers comprising glass fibers, carbon fibers, aramid fibers, or nanoscale fibers; and (ii) stitching a plurality of stitches of a thermally conductive fiber through the at least one sheet, thereby forming a stitched composite material. The at least one sheet may be a composite structure or a component ultimately intended to be combined with other materials into a composite. For example, the sheet may consist only of the woven or non-woven glass. carbon, aramid, nanoscale, or other fibers, or the sheet may further comprise other materials, e.g., in one or more adjacent layers (i.e., a laminate structure) or as a matrix material, such as a resin coating and/or infiltrating the woven or non-woven glass, carbon, aramid, nanoscale, or other fibers.

The method of making a composite may also include a step of identifying a suitable thermally conductive and stitchable material for use as the thermally conductive fiber for a particular application. Embodiments of suitable thermally conductive fibers have a thermal conductivity of at least about 10 W/mK and are stitchable (i.e., are flexible and strong enough to be stitched). For example, 0.006″ high purity copper wire from McMaster-Carr, K-1100 Graphite fiber from BP Amoco Performance Products and 3Tex nanotube yarns from Nanocomp may be used as stitchable materials.

According to certain embodiments of the method, the stitching process threads the thermally conductive material through at least a portion of, or the entirety of, the Z-axis thickness of the sheet. This may done in at any of various stages of forming a composite structures, such as at the fiber preform, pre-cure, or prepreg layup states. For example, stitching may be implemented after the composite reinforcement layers to be stitched are stacked together (e.g., five layers of carbon fabric).

The stitching process may be conducted by essentially any method known in the art for stitching, including hand stitching or using a sewing machine. A hand stitching process may allow for ease of making samples and may be of low cost and flexible for completed or smaller composites. Using a sewing machine for stitching may be similar to stitching layers of fabric for making clothes such that the stitch distance may be adjusted, may be faster in production, and may accurately produce the stitch pattern desired. In some embodiments, programmable sewing machines, such as the Quantum XL-6000 by Singer with a desired pattern, are used. In certain embodiments, different stitching patterns are used to improve through-thickness thermal conductivity values in composites.

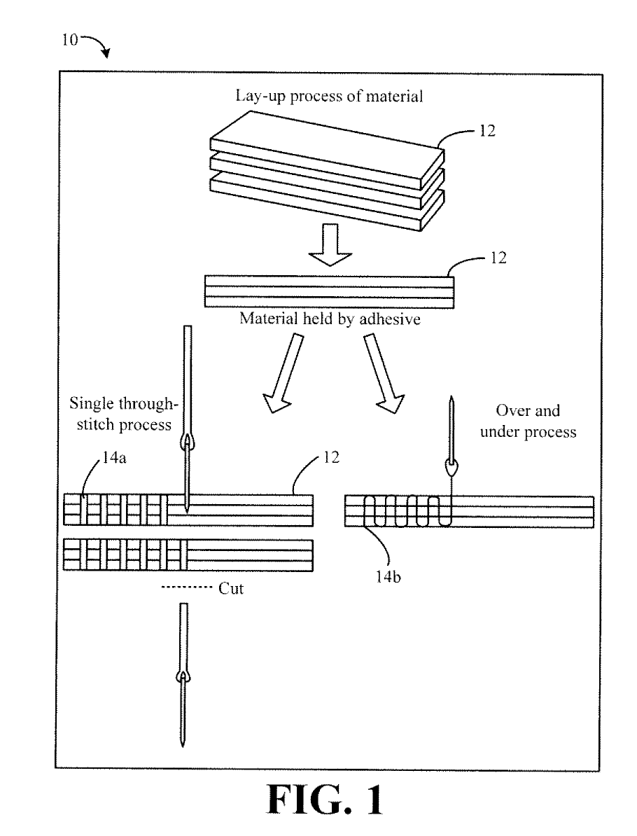

FIG. 1 illustrates two embodiments of the method 10, in which composite layers 12 are stacked and adhered together. Then, the composite layers may be either (a) stitched using single-through stitching so that stitches 14a having cut ends results, or (b) stitched using over-and-under stitching so that the stitches 14b are connected. Certain metallic wires or other thermal conducting fiber may have a tension strength that is too low to withstand the stresses applied to it by a sewing machine. One embodiment of a process for stitching with such low tension materials includes performing a series of single through-stitches, wherein the wire of fiber is cut after each stitch, and then the step is repeated at another location in the sheet Alternately, an over-and-under process and/or a sewing machine can be used, particularly with composite yarns and nanotube yarns, to make a high strength composite.

In preferred embodiments, in-plane fiber or matrix material damage is avoided or limited during the stitching process so unwanted changes in the mechanical properties of the composite are avoided or minimized. According to certain embodiments, Dritz, Singer, and Schemtz quilting embroidery needles are used to stitch the conductive fibers into the composite. In particular embodiments, the fine point of the needle allows stitching through the weave of a composite fabric or other composite structure (e.g., threading the needle and thermally conductive fiber between fibers of the weave or between adjacent composite structures) with very minimal damage or disturbance to the composite layer. Thus, the overall structure is not damaged and fabric weaves are not broken. The fibers or composite structure may be formed around the threaded material (i.e., the stitch), making as much contact as possible. In certain embodiments, various threaded materials, such as metallic wires, are functionalized or treated to improve surface bonding with the matrix material or other structure of the composite. As the composite is not damaged by the stitching, the mechanical properties do not degrade.

In some embodiments, stitched composite layers undergo composite fabrication processes for making final composites, such as vacuum-assisted resin transfer molding (VARTM), resin transfer molding (RTM), vacuum infusion process (VIP), autoclave/prepreg process, carbon-carbon impregnation, or a combination thereof. According to certain embodiments, stitched composites are made into prepregs. In such embodiments where the stitching is carried out before a resin or other matrix material is applied to a composite layer, the matrix material not only avoids damage from the stitching process, but also can be made to adhere to the stitches, thereby bonding the components of the composite together.

Thus, the method may include stitching as an integrated step of composite fabrication, such that the stitching is not a pre- or post-process which modifies the overall microstructure of the final composite. The stitching may be performed before composite curing when the composite materials are flexible and the in-plane fibers are free to move, thus avoiding or reducing damage to the in-plane fibers and/or to the stitchable materials, as well as providing more options for production. Embodiments of the method have the advantage of making very large stitched composite materials for as long as the stitching is needed, since stitching on fiber sheet materials before curing could be a continuous process (rather than batch process), which is not limited by the size of the composite manufacturing devices (e.g., vacuum ovens and/or autoclaves).

### The Composite

In another aspect, a composite material is provided which includes: (i) at least one sheet which comprise woven or non-woven fibers, the woven or non-woven fibers comprising glass fibers, carbon fibers, aramid fibers, or nanoscale fibers; and (ii) a plurality of stitches of a thermally conductive fiber through the at least one sheet, wherein the thermally conductive fiber is present in the composite sheet material in an amount effective to the appreciably enhance the thermal conductivity of the composite material in the Z-axis, relative to the thermal conductivity of the unstitched composite or the unstitched sheet of woven or non-woven glass fibers, carbon fibers, aramid fibers, or nanoscale fibers, In one embodiment, this enhancement can be achieved by having the stitches of the thermally conductive fiber present in the composite sheet material in an amount of at least about 0.5 volume % of the composite material. In another embodiment, the thermally conductive fiber is present in the composite sheet material in an amount between about 1 volume % and about 30 volume % of the composite sheet material. In yet another embodiment, the thermally conductive fiber is present in the composite sheet material in an amount between about 1 volume % and about 15 volume % of the composite sheet material.

In a preferred embodiment, the composite material includes two or more of the sheets stitched together with the thermally conductive fiber.

In a preferred embodiment, the composite sheet material further includes a polymeric matrix material. In certain embodiments, the composite sheet material further includes a carbon matrix material, a metal matrix material, or a ceramic matrix material. It may be a thermoplastic or thermoset resin. In one embodiment, the polymeric matrix material comprises a cured or B-stage cured resin. Such resins are well known in the art.

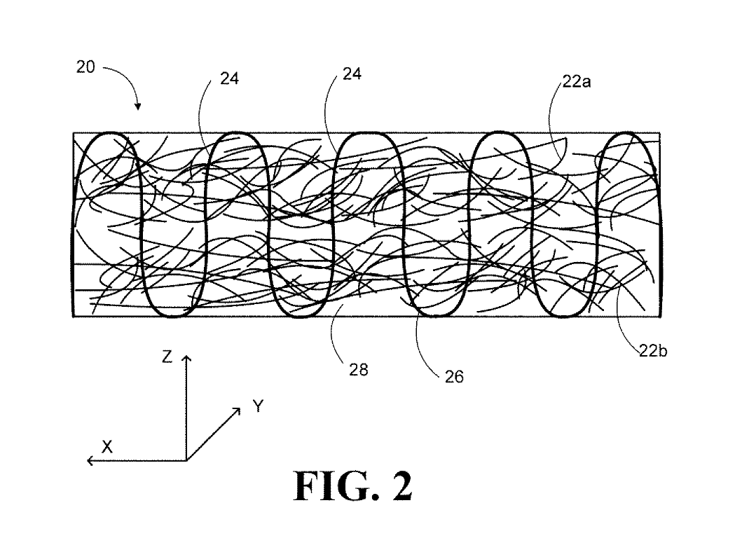

FIG. 2 illustrates an embodiment of a composite material 20 comprising two sheets of non-woven fibers 22a, 22b, a plurality of stitches 24 of a thermally conductive fiber 26, and a polymeric matrix material 28.

The stitches of the thermally conductive fiber can be in various forms, depending for example of the particular stitching or sewing process utilized. In one embodiment. wherein the stitches comprise single through-stitching. In another embodiment, the stitches comprise over-and-under stitching. In one embodiment, the sheet comprises a fiber weave and the thermally conductive fiber is threaded between the fibers of the fiber weave.

The Sheet Material

In one embodiment, the stitches are formed in one or more sheets of a material. In one embodiment, the sheet comprises woven or non-woven fibers. In various embodiments, the sheet comprises a fabric of the woven or non-woven fibers. In a preferred embodiment, the woven or non-woven fibers are glass fibers, carbon fibers, aramid fibers, nanoscale fibers, or a combination thereof, In one embodiment, the sheet materials comprise thin films of glass fibers, carbon fibers, aramid fibers nanoscale fibers, or a combination thereof. Other fibers may also be suitable. Examples of suitable fabric sheet materials include fiberglass, carbon, aramid fabrics, nanoscale fiber film (e.g., nanotube buckypaper, or nanotube sheet, produced by Nanocomp of Concord, N.H.), nanoscale fibers, nanoscale composite fibers, nanoscale fiber yarns, nanotube yarns, carbon felt, prepregs, polymer-based materials. nonwoven sheets of various fiber materials, and the like.

The sheet optionally may further include additional materials, such as one or more layers of another material. The additional material may be a polymer or a polymer precursor. It may be in the form of a film or a matrix material, such as a resin coating and/or infiltrating the woven or non-woven glass, carbon, aramid, nanoscale, or other fibers.

The composite may comprise one, two, three, four, or more sheets stacked adjacent to each other. In some embodiments, the composite has a thickness ranging from about 0.5 mm to about 25.4 mm.

In certain embodiments, the composite include one or more adhesives (e.g., 3M Super 77 Multipurpose Adhesive). The adhesive may be used to hold the fabrics or material assemblies together, for example, to facilitate the stitching process described herein.

Thermally Conductive Fibers

As used herein, the term “thermally conducting fiber” refers to a pliable wire, thread, cord, ribbon, yarn, or the like, or any combination thereof having a thermal conductivity of at least about 10 W/mK and being, suitable for stitching a composite layer. In a preferred embodiment, the thermally conductive fibers have a thermal conductivity of at least about 50 W/mK.

Representative examples of suitable materials for use as thermally conductive fibers include metallic wires (e.g., copper, aluminum, silver, etc.), carbon fiber materials (e.g., conductive carbon fiber yarn such as K-1100 from BP Amoco Performance Products), nanoscale fibers (e.g., nanoscale composite fibers produced by electro-spinning processes with high (>10 wt. %) conducting filler contents), nanoscale composite fibers. carbon nanotube yarn (e.g., 3 Tex nanotube yarns from Nanocomp), metal-coated polymeric monofilament or yarn (e.g., nickel-coated polymer fibers or boron yarns, copper-coated yarns, Ag—Cu-coated yarns, or Ni—Ag—Cu-coasted yarns), or any other conducting and stitchable yarns or materials.

In certain embodiments, the metallic wire has a diameter of 0.003″, 0.006″, or 0.01″. Narrower diameter metallic wires may also be used in some embodiments.

In some embodiments, the thermally conductive fibers are pre-treated or pre-modified to make them suitable for stitching. For example, K-1100 high conducting carbon fiber may be too brittle for stitching. Twisting (or bundling together) and epoxy coating of the carbon fiber makes it more flexible for stitching. In other embodiments. thermally conductive fibers are pretreated or pre-combined into larger threads before stitching them into a composite layer. In yet other embodiments, thermally conductive fibers are coated or impregnated with a polymer to make the fibers stitchable.

In certain embodiments, the thermally conductive fibers are present in the composite sheet material an amount ranging from about 0.5 volume % to about 30 volume % of the volume of the composite material. In other embodiments, the thermally conductive fibers are present in an amount greater than about 15 volume % of the composite volume. It should be understood by a person of ordinary skill in the art that the amount of thermally conductive fiber present in the composite may be selected to achieve a desired thermal conductivity. This, in turn, may depend on the through-thickness thermal conductivity required for a given application.

In particular embodiments, the through-thickness conductivity of a composite is increased by up to about five (5) times the base value of the through-thickness conductivity of the composite. As used herein, “base value of the through-thickness thermal conductivity”refers to the through-thickness thermal conductivity measured for a composite without a stitch comprising a thermally conductive fiber through a thickness of the composite. In other embodiments, the through-thickness conductivity of a composite is increased by up to about twenty-seven (27) times the base value of the through-thickness conductivity of the composite.

Nanoscale Fibers and Nanoscale Fiber Films

In certain embodiments, the composites may include nanoscale fibers and nanoscale fiber films in the composite layer, the thermally conductive fibers, or both. Since certain nanoscale fibers and nanoscale fiber films have high thermal conductivity interactions between the stitched fibers and these materials may result in more efficient heat dissipation within the composites, thus facilitating heat flow in the through-thickness direction.

As used herein, the term “nanoscale fibers” refers to a thin, greatly elongated solid material, typically having a cross-section or diameter of less than about 500 nm. In certain embodiments, the nanoscale fibers are single-walled carbon nanotubes (SWNTs), multiple-walled carbon nanotubes (MWNTs), carbon nanofibers (CNFs), or mixtures thereof. Carbon nanotubes and carbon nanofibers have high surface areas (e.g., about 1,300 m²/g), which results in high conductivity and high multiple internal reflection. In a preferred embodiment, the nanoscale fibers comprise or consist of carbon nanotubes, including both SWNTs and MWNT. SWNTs typically have small diameters (˜1-5 nm) and large aspect ratios, while MWNTs typically have large diameters (˜5-200 nm) and small aspect ratios. CNFs are filamentous fibers resembling whiskers of multiple graphite sheets or MWNTs.

As used herein, the terms “carbon nanotube” and the shorthand “nanotube” refer to carbon fullerene, a synthetic graphite, which typically has a molecular weight between about 840 and greater than about 10 million grams/mole. Carbon nanotubes are commercially available, for example, from Unidym Inc. (Houston, Tex. USA), or can be made using techniques known in the art.

The nanotubes optionally may be opened or chopped, for example, as described in U.S. Patent Application Publication No. 2006/0017191 A1.

The nanotube and nanofibers optionally may be chemically modified or coated with other materials to provide additional functions for the films produced. For example, in some embodiments, the carbon nanotubes and CNFs may be coated with metallic materials to enhance their conductivity.

Nanoscale fiber yarns or nanotube yarns may be made through spinning processes, such as 3Tex nanotube yarns from Nanocomp.

As used herein, the term “nanoscale film” refers to thin, preformed sheets of well-controlled and dispersed porous networks of SWNTs, MWNTs, CNFs, or mixtures thereof. Films of carbon nanotubes and nanofibers, or buckypapers, are a potentially important material platform for many applications. Typically, the films are thin, preformed sheets of well-controlled and dispersed porous networks of SWNTs, MWNTs, carbon nanofibers CNFs, or mixtures thereof. The carbon nanotube and nanofiber film materials are flexible, light weight, and have mechanical, conductivity, and corrosion resistance properties desirable for numerous applications. The film form also makes nanoscale materials and their properties transferable to a macroscale material for ease of handling.

The nanoscale fiber films used in the sensors may be made by essentially any suitable process known in the art.

In some embodiments, the nanoscale fiber film materials are made by a method that includes the steps of (1) suspending SWNTs, MWNTs, and/or CNF in a liquid, and then (2) removing a portion of the liquid to form the film material. In one embodiment, all or a substantial portion of the liquid is removed. As seen herein, “a substantial portion” means more than about 50%, typically more than 70, 80%, 90%, or 99% of the liquid. The step of removing the liquid may include a filtration process, vaporizing the liquid, or a combination thereof. For example, the liquid removal process may include, but is not limited to, evaporation (ambient temperature and pressure), drying, lyophilization, heating to vaporize, or using a vacuum.

The liquid includes a non-solvent, and optionally may include a surfactant (such as Triton X-100, Fisher Scientific Company, N.J.) to enhance dispersion and suspension stabilization. As used herein, the term “non-solvent” refers to liquid media that essentially are non-reactive with the nanotubes and in which the nanotubes are virtually insoluble. Examples of suitable non-solvent liquid media include water, and volatile organic liquids, such as acetone, ethanol, methanol, n-hexane benzene, dimethyl formamide, chloroform, methylene chloride, acetone, or various oils. Low-boiling point liquids are typically preferred so that the liquid can be easily and quickly removed from the matrix material. In addition, low viscosity liquids can be used to form dense conducting networks in the nanoscale fiber films.

For example, the films may be made by dispersing nanotubes in water or a non-solvent to form suspensions and then filtering the suspensions to form the film materials. In one embodiment, the nanoscale fibers are dispersed in a low viscosity medium such as water or a low viscosity non-solvent to make a suspension and then the suspension is filtered to form dense conducting networks in thin films of SWNT, MWNT, CNF or their mixtures. Other suitable methods for producing nanoscale fiber film materials are disclosed in U.S. patent application Ser. No. 10/726,074, entitled “System and Method for Preparing Nanotube-based Composites;” U.S. Patent Application Publication No. 2008/0280115, entitled “Method for Fabricating Macroscale Films Comprising Multiple-Walled Nanotubes;” and U.S. Pat. No. 7,459,121 to Liang et al., which are incorporated herein by reference.

Additional examples of suitable methods for producing nanoscale fiber film materials are described in S. Wang, Z. Liang, B. Wang, and C. Zhang, “High-Strength and Multifunctional Macroscopic Fabric of Single-Walled Carbon Nanotubes,” Advanced Materials, 19, 1257-61 (2007); Z. Wang, Z. Liang, B. Wang, C. Zhang and L. Kramer, “Processing and Property Investigation of Single-Walled Carbon Nanotube (SWNT) Buckypaper/Epoxy Resin Matrix Nanocomposites,” Composite, Part A: Applied Science and Manufacturing, Vol. 35 (10), 1119-233 (2004); and S. Wang, Z. Liang, G. Pham, Y. Park, B. Wang, C. Zhang, L. Kramer, and P. Funchess, “Controlled Nanostructure and High Loading of Single-Walled Carbon Nanotubes Reinforced Polycarbonate Composite,” Nanotechnology, Vol. 18, 095708 (2007).

In certain embodiments, the nanoscale fiber films are commercially available nanoscale fiber films. For example, the nanoscale fiber films may be preformed nanotube sheets made by depositing synthesized nanotubes into thin sheets (e.g., nanotube sheets from Nanocomp Technologies Inc., Concord, N.H.).

The nanotubes and CNFs may be randomly dispersed, or may be aligned, in the produced films. In one embodiment, the fabrication method further includes aligning the nanotubes in the nanoscale fiber film, For example, aligning the nanotubes may be accomplished using in situ filtration of the suspensions in high strength magnetic fields, as described for example, in U.S. Patent Application Publication No. 2005/0239948 to Haik et al. In various embodiments, good dispersion and alignment are realized in buckypapers materials, which assists the production of high nanoscale fiber content (i.e., greater than 20 wt. %) buckypaper for high performance composites materials. In various embodiments, the films have an average thickness from about 5 to about 100 microns thick with a basis weight (i.e., area density) of about 20 g/m² to about 50 g/m².

In certain embodiments, the composite may comprise high-strength and high conductivity stitching materials, such as carbon nanotube yarns and K-1100 carbon fibers. Increased through-thickness mechanical and electrical conductivity properties with these materials may be attractive for use in many high-performance and multifunctional composite applications.

The present composites and methods can be further understood in view of the following non-limiting examples.

### EXAMPLE 1

A fiberglass fabric composite with through-thickness stitched copper wires (i.e., 0.006″ high purity copper wire from McMaster-Carr) and CNT yarn (i.e., 3Tex nanotube yarns from Nanocomp (about 20-80 microns in diameter. 2-5 gram/kilometer, and 1.33 g/cm² density)) was made. A fine point needle was used to stitch the wires and yarns through the fiberglass material to form the composite. The composite was then cured with Epon 862 from flexion Specialty Chemicals using a VIP process. The stitching patterns, copper wires, and nanotube yarns were visible at the surface of the samples. The volume fractions of copper and nanotube yarns in the composites were 5 volume % and 0.4 volume % respectively.

### EXAMPLE 2

Three samples were made with three layers of E-glass fiber and Epon 862. Sample 1 had 0.4% CNT yarn (i.e., 3Tex nanotube yarns from Nanocomp (about 20-80 microns in diameter, 2-5 gram/kilometer, and 1.33 g/cm² density)) by volume fraction (V_{f}), Sample 2 had 1.8% copper by V_{f}, and Sample 3 had 5.0% copper by V_{f} stitched into a E-glass fiber preform. The copper wire was 0.006″ high purity copper wire from McMaster-Carr. The CNT yarn was stitched using the over-and-under technique, while the copper sample was made with the single through-stitch technique.

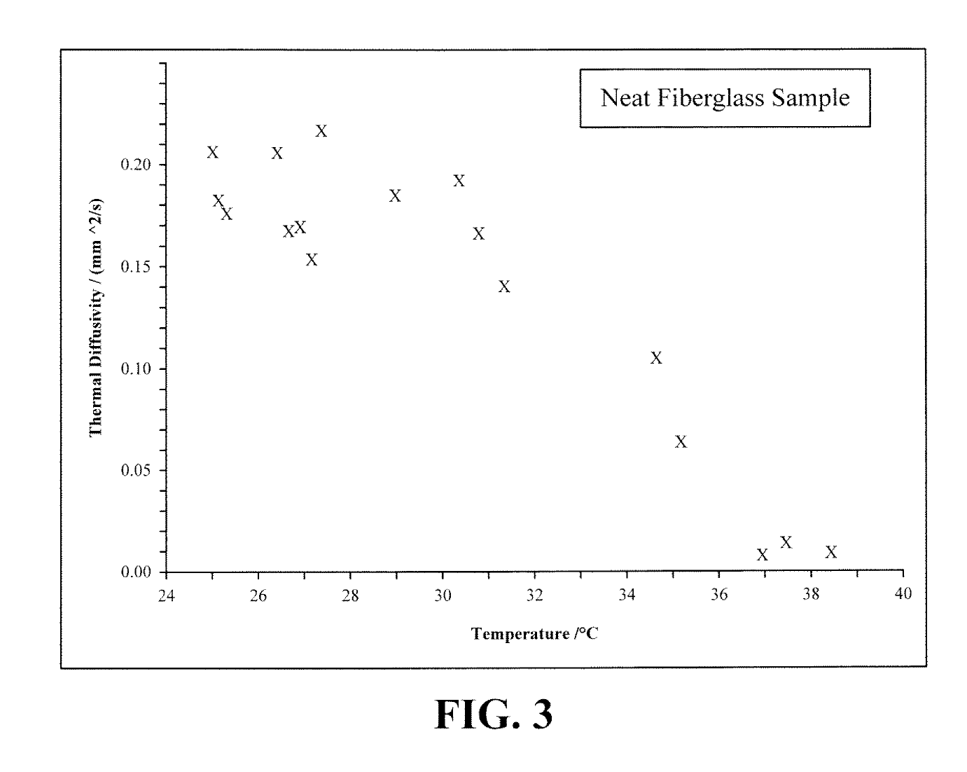

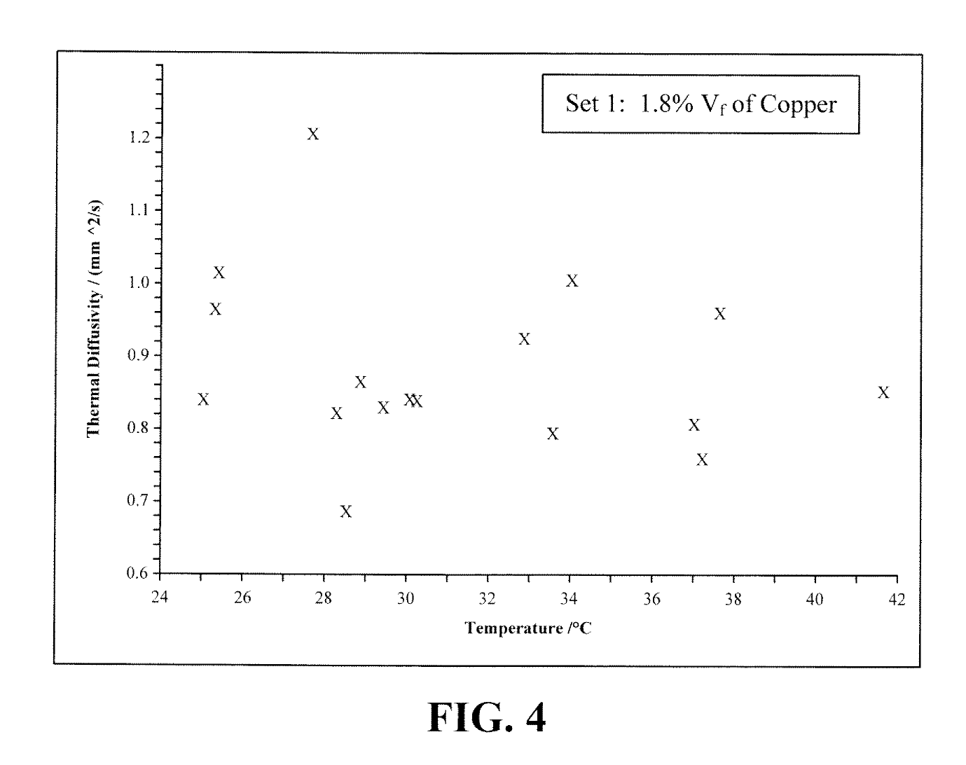

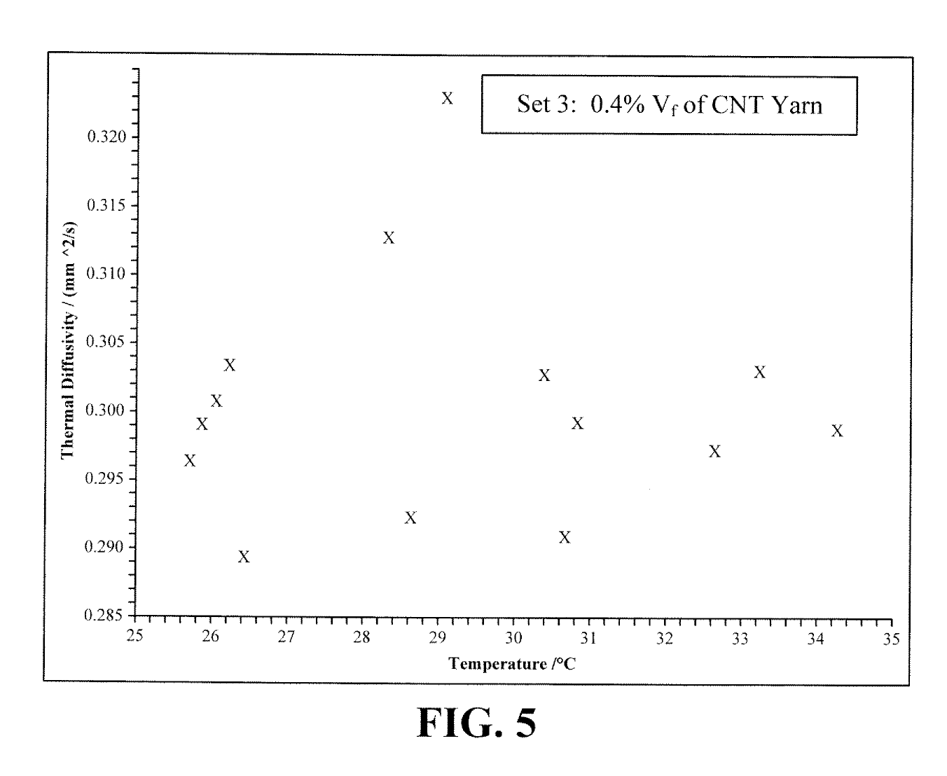

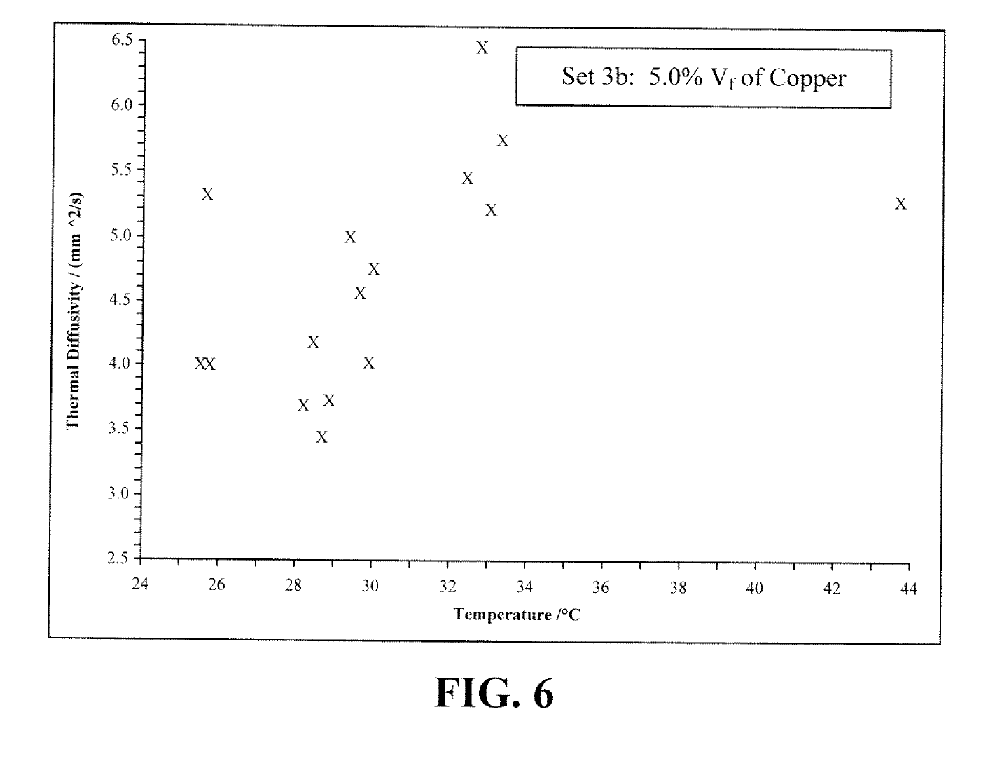

The experimental results showed significant increases in through-thickness thermal conductivity. The fiberglass samples were tested in a Netzsch LEA 457 Microflash machine and the thermal diffusivity results are shown in FIGS. 3-6. Table 1 shows the comprehensive results data collected on the samples stitched with CNT yarn and copper wire and provide the calculated thermal conductivity. The thermal conductivity was calculated by multiplying the thermal diffusivity, density, and specific heat of the samples. The specific heat used was 0.81 J/gK, through the specific heat of the fiberglass composite may range as high as 0.96 J/gK. Therefore, the thermal conductivity calculation of the sample was at the low end. V_{f} is the volume fraction of the stitched materials in the composites. V_{f} is calculated by determining the total amount (i.e., mass) of the stitched fibers in the composite, calculating the volume of the stitched fibers using the density of the stitched fiber, and dividing by the stitched composite volume.

TABLE 1
Collected data on fiberglass samples with copper and nanotube yarns

| | | | | Thermal |
|---|---|---|---|---|
| | Density | Thickness | Diffusivity | Conductivity |
| Sample | (g/cm³) | (mm) | (avg. mm²/s) | (W/mK) |
| CNT yarn/0.4% V_{f} | 1.943 | 1.96 | 0.3 | 0.47 |
| Cu wire/1.8% V_{f} | 2.052 | 2.4 | 0.9 | 1.48 |
| Cu wire/5.0% V_{f} | 2.03 | 2.4 | 5.0 | 8.12 |
| Neat glassfiber | 1.985 | 2.3 | 0.18 | 0.29 |
| composite without | | | | |
| stitching (control) | | | | |

The results shows that the methods of stitching thermally conductive fibers into a composite according to embodiments of the present disclosure increases the thermal conductivity, while making a negligible difference in the density due to the limited amount of the stitching material used.

Publications cited herein and the material for which they are cited are specifically incorporated by reference. Modifications and variations of the methods and devices described herein will be obvious to those skilled in the art from the foregoing detailed description. Such modifications and variations are intended to come within the scope of the appended claims.

We claim:

1. A method for making a composite material comprising:
providing at least one sheet which comprise woven or non-woven fibers, the woven or non-woven fibers comprising glass fibers, carbon fibers, aramid fibers, or nanoscale fibers; and
stitching a plurality of stitches of a thermally conductive fiber through the at least one sheet, thereby forming a stitched composite material.

2. The method of claim 1, wherein, following the stitching, the thermally conductive fiber is present in the stitched composite material in an amount from about 0.5 volume % to about 30 volume % of the stitched composite material.

3. The method of claim 1, wherein the stitching comprises single through-stitching.

4. The method of claim 1, wherein the stitching comprises over-and-under stitching.

5. The method of claim 1, wherein the thermally conductive fiber comprises a metallic wire, carbon fibers. a nanoscale composite fiber, a carbon nanotube yarn, a metal-coated polymeric monofilament, or a metal-coated polymeric yarn.

6. The method of claim 1, wherein the sheet comprises a fiber weave and the stitching threads the thermally conductive fiber between the fibers of the fiber weave.

7. The method of claim 1, wherein two or more of the sheets which comprise woven or non-woven fibers are stitched together with the thermally conductive fiber.

8. The method of claim 1, further comprising impregnating the stitched composite material with a resin and then curing or B-stage curing the resin.

9. A composite sheet material comprising:
at least one sheet which comprise woven or non-woven fibers, the woven or non-woven fibers comprising glass fibers, carbon fibers, aramid fibers, or nanoscale fibers; and
a plurality of stitches of a thermally conductive fiber through the at least one sheet,
wherein the thermally conductive fiber is present in the composite sheet material in an amount of at least about 0.5 volume % of the composite material.

10. The composite sheet material of claim 9, wherein the thermally conductive fiber is present in the composite sheet material in an amount between about 1 volume % and about 15 volume % of the composite sheet material.

11. The composite sheet material of claim 9, wherein the stitches comprise single through-stitching.

12. The composite sheet material of claim 9, wherein the stitches comprise over-and-under stitching.

13. The composite sheet material of claim 9, wherein the thermally conductive fiber comprises a metallic wire, carbon fibers, a nanoscale composite fiber, a carbon nanotube yarn, a metal-coated polymeric monofilament, or a metal-coated polymeric yarn.

14. The composite sheet material of claim 9, wherein the sheet comprises a fiber weave and the thermally conductive fiber is threaded between the fibers of the fiber weave.

15 The composite sheet material of claim 9, which comprises two or more of the sheets stitched together with the thermally conductive fiber.

16. The composite sheet material of claim 9, further comprising a polymeric matrix material, a carbon matrix material, a metal matrix material, or a ceramic matrix material.

17. The composite sheet material of claim 9, further comprising a polymeric matrix material which is a cured or B-stage cured resin.
